(19) United States
(12) Patent Application Publication
(10) Pub. No.: US 2014/0317498 A1
(43) Pub. Date: Oct. 23, 2014

(54) INFORMATION PRESENTATION METHOD AND ELECTRONIC DEVICE

(71) Applicant: Panasonic Corporation, Osaka (JP)

(72) Inventors: Ryo OKUMURA, Osaka (JP); Yusuke ADACHI, Osaka (JP)

(73) Assignee: Panasonic Corporation, Osaka (JP)

(21) Appl. No.: 14/254,919

(22) Filed: Apr. 17, 2014

(30) Foreign Application Priority Data
Apr. 18, 2013 (JP) 2013-087165
Apr. 16, 2014 (JP) 2014-084303

(51) Int. Cl. G06F 3/01

(52) U.S. Cl. CPC G06F 3/016
USPC 715/702

(57) ABSTRACT

A method according to an embodiment of the present disclosure is a method of notifying a specific option among plural options to a user by using an electronic device 1, including a step of detecting plural touches made by the user on the touch pad 10. The plural options including the specific option are determined according to a situation of use of the electronic device 1. The plurality of touched positions on the touch pad 10 are associated with the plural options. There is further included a step of presenting a tactile sensation at a touched position among the plurality of touched positions that is associated with the specific option, the tactile sensation being distinct from that for any other touched position.

### BACKGROUND

1. Technical Field

The present disclosure relates to a method and electronic device for presenting information via tactile sensation.

2. Description of the Related Art

Japanese Laid-Open Patent Publication No. 2000-089754 discloses a glove to be worn on a hand of a player of a musical instrument, with stimulators being provided at portions of the glove respectively corresponding to the player's fingers. In the case of a keyboard instrument, based on fingering data for a piece of music, the stimulators present stimulations to the fingers that are to press down keys.

### SUMMARY

The present disclosure provides a method and electronic device for, among a plurality of options, notifying a specific option to a user via tactile sensation.

A method according to an embodiment of the present disclosure is a method of notifying a specific option among plural options to a user by using an electronic device, comprising a step of detecting plural touches made by the user on a touch pad, wherein, the plural options including the specific option are determined according to a situation of use of the electronic device, and a plurality of touched positions on the touch pad are associated with the plural options, the method further comprising: a step of presenting a tactile sensation at a touched position among the plurality of touched positions that is associated with the specific option, the tactile sensation being distinct from that for any other touched position.

Moreover, a method according to an embodiment of the present disclosure is a method of notifying a specific option among plural options to a user by using an electronic device, comprising a step of detecting a touch made by the user on a touch pad, wherein, the plural options including the specific option are determined according to a situation of use of the electronic device, and touches on the touch pad are associated with the plural options, the method further comprising: a step of presenting a tactile sensation in response to a touch that is associated with the specific option, the tactile sensation being distinct from that for any other touch.

An electronic device according to an embodiment of the present disclosure is an electronic device for notifying a specific option among plural options to a user, the electronic device comprising: a touch pad for detecting a plurality of touched positions touched by the user; and a tactile presentation section for presenting a tactile sensation at at least one of the plurality of touched positions, wherein, the plural options including the specific option are determined according to a situation of use of the electronic device; the plurality of touched positions are associated with the plural options; and the tactile presentation section presents a tactile sensation at a touched position among the plurality of touched positions that is associated with the specific option, the tactile sensation being distinct from that for any other touched position.

Moreover, an electronic device according to an embodiment of the present disclosure is an electronic device for notifying a specific option among plural options to a user, the electronic device comprising: a touch pad for detecting a touch made by the user, and a tactile presentation section for presenting a tactile sensation at a touched position on the touch pad, wherein, the plural options including the specific option are determined according to a situation of use of the electronic device; touches on the touch pad are associated with the plural options; and the tactile presentation section presents a tactile sensation to a touch that is associated with the specific option, the tactile sensation being distinct from that for any other touch.

Moreover, a computer program according to an embodiment of the present disclosure is a computer program for causing an electronic device to execute a process of notifying a specific option among plural options to a user, the computer program causing a computer in the electronic device to execute a process of detecting plural touches made by the user on a touch pad, wherein, the plural options including the specific option are determined according to a situation of use of the electronic device, and a plurality of touched positions on the touch pad are associated with the plural options, the computer program causing the computer in the electronic device to execute a process of presenting a tactile sensation at a touched position among the plurality of touched positions that is associated with the specific option, the tactile sensation being distinct from that for any other touched position.

Moreover, a computer program according to an embodiment of the present disclosure is a computer program for causing an electronic device to execute a process of notifying a specific option among plural options to a user, the computer program causing a computer in an electronic device to execute a process of detecting a touch made by the user on a touch pad, wherein, the plural options including the specific option are determined according to a situation of use of the electronic device, and touches on the touch pad are associated with the plural options, the computer program causing the computer in the electronic device to execute a process of presenting a tactile sensation in response to a touch that is associated with the specific option, the tactile sensation being distinct from that for any other touch.

According to one aspect of the present disclosure, a specific option among plural options can be notified to a user via tactile sensation.

### BRIEF DESCRIPTION OF THE DRAWINGS

FIG. 1A is a diagram showing an electronic device according to an embodiment.

FIG. 1B is a diagram showing an electronic device according to an embodiment.

FIG. 2A is a diagram showing an piezoelectric element of an electronic device according to an embodiment.

FIG. 2B is a diagram showing a piezoelectric element of an electronic device according to an embodiment.

FIG. 3A is a diagram showing a situation of use for an electronic device according to an embodiment.

FIG. 3B is a diagram showing an operation of an electronic device according to an embodiment.

FIG. 4 is a flowchart showing an operation of an electronic device according to an embodiment.

FIG. 5A is a diagram showing an operation of an electronic device according to an embodiment where the number of options and the number of points of contact are equal.

FIG. 5B is a diagram showing an operation of an electronic device according to an embodiment where the number of points of contact is greater than the number of options.

FIG. 5C is a diagram showing an operation of an electronic device according to an embodiment where the number of points of contact is smaller than the number of options.

FIG. 6A is a diagram showing a mapping method according to an embodiment where the number of options is not equal to the number of points of contact.

FIG. 6B is a diagram showing a mapping method according to an embodiment where the number of options is not equal to the number of points of contact.

FIG. 6C is a diagram showing a mapping method according to an embodiment where the number of options is not equal to the number of points of contact.

FIG. 6D is a diagram showing a mapping method according to an embodiment where the number of options is not equal to the number of points of contact.

FIG. 7A is a diagram showing a mapping method of an electronic device according to an embodiment.

FIG. 7B is a diagram showing a mapping method of an electronic device according to an embodiment.

FIG. 7C is a diagram showing a mapping method of an electronic device according to an embodiment.

FIG. 8 is a timing chart showing a mapping method of an electronic device according to an embodiment.

FIG. 9 is a diagram showing a mapping method of an electronic device according to an embodiment.

FIG. 10A is a mapping method between options and pressure forces according to an embodiment.

FIG. 10B is a diagram showing an electronic device according to an embodiment.

FIG. 11A is a diagram showing an example usage of an electronic device according to an embodiment.

FIG. 11B is a diagram showing an example usage of an electronic device according to an embodiment.

### DETAILED DESCRIPTION

Hereinafter, with adequate reference to the drawings, embodiments will be described in detail. However, unnecessary details may be omitted from description. For example, matters that are well known may not be described in detail, and substantially identical component elements may not be redundantly described. This is to avoid lengthiness of the following description, and to facilitate understanding by those skilled in the art.

The attached drawings and the following description are provided by the inventors to allow those skilled in the art to sufficiently understand the present disclosure, without the intention of limiting the subject matter that is recited in the claims.

### Embodiment 1

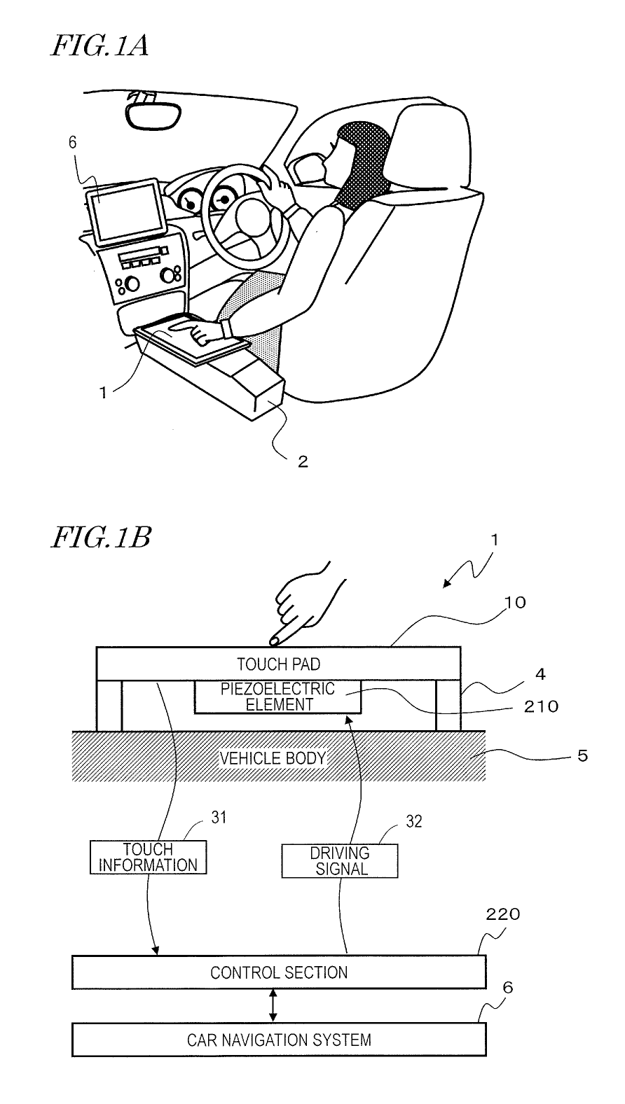

Hereinafter, an electronic device according to Embodiment 1 will be described with reference to FIGS. 1A to 5C.

[1-1. Construction]

<Construction of Electronic Device 1>

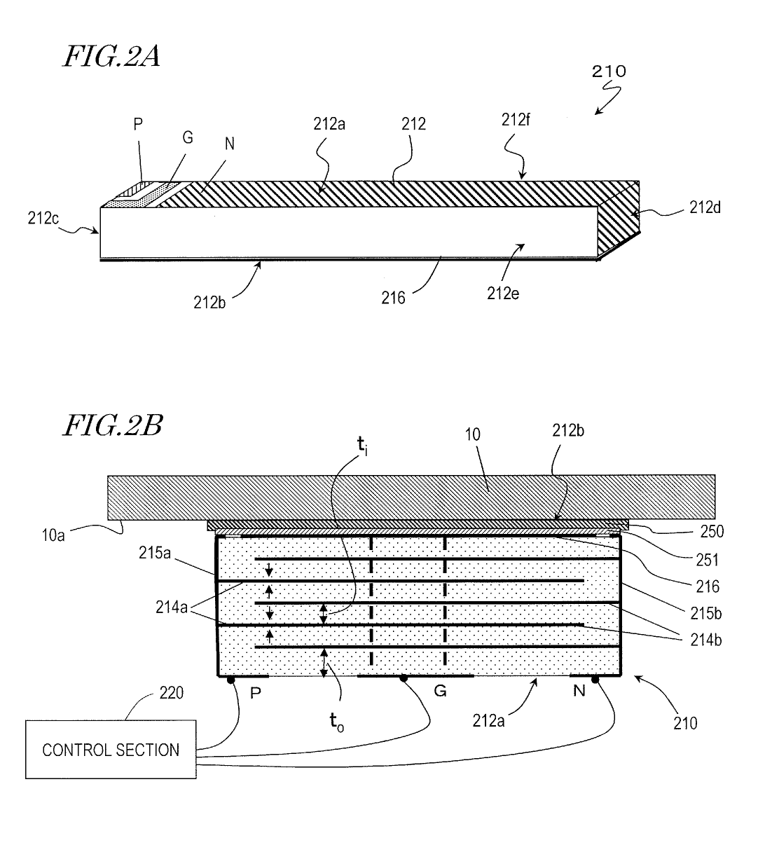

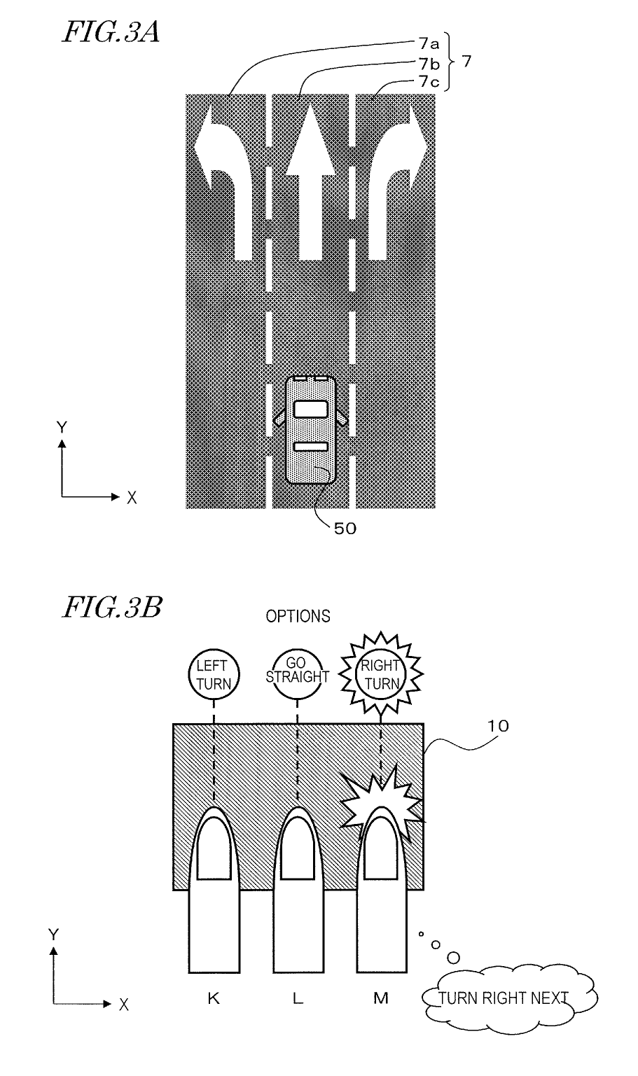

First, with reference to FIG. 1A to FIG. 2B, an electronic device 1 according to Embodiment 1 will be described. The electronic device 1 is a device which presents information via tactile sensation in response to a touch operation by a user, and may be a touch input device, for example. As an example, the present embodiment will illustrate an electronic device 1 which is placed in an automobile.

FIG. 1A shows the appearance of the electronic device 1 placed in an automobile. For example, the electronic device 1 is placed at a so-called center console section 2, which is in between the driver's seat and the passenger seat.

By using the electronic device 1, a user is able to manipulate an onboard electronic device or the like, e.g., a car navigation system 6, a car audio system (not shown), or an air conditioner (not shown).

The automobile has the car navigation system 6 placed therein. By using the electronic device 1, the user is able to manipulate the car navigation system 6 so as to provide navigation assistance to a destination.

As shown in FIG. 1B, the electronic device 1 includes a touch pad 10, a spacer 4, a piezoelectric element 210, and a control section 220. The touch pad 10 to be touched by the user is fixed to a vehicle body 5 via the spacer 4.

The touch pad 10 detects a touch of the user on the touch pad 10. For example, the touch pad 10 detects the respective coordinates of a plurality of touched positions on the touch pad 10. On the rear face of the touch pad 10 is fixed the piezoelectric element 210, which presents a tactile sensation to the user by vibrating the touch pad 10. For example, the piezoelectric element 210 presents a tactile sensation in at least one of a plurality of touched positions on the touch pad 10.

The touch pad 10 is connected to the control section 220. The control section 220, which controls the touch pad 10, receives touch information 31 of the user from the touch pad 10 and sends it to the car navigation system 6. Based on the touch information received form the touch pad 10 and external information concerning navigation assistance, e.g., roads, that is received from the car navigation system 6, the control section 220 outputs a driving signal 32 to the piezoelectric element 210 for vibrating the touch pad 10 so as to present a tactile sensation to the user. Based on an instruction from the car navigation system 6, the control section 220 drives the piezoelectric element 210 to present a tactile sensation to the user.

The control section 220 is implemented as a microcomputer, for example. The control section 220 may be implemented in hardware alone, or a combination of hardware and software. The control section 220 may include an amplifier for amplifying a driving signal or the like. The control section 220 may be a part of the car navigation system 6, or included in the electronic device 1 or any other device.

In accordance with the situation of use for the electronic device 1, the control section 220 determines plural options such that a specific option is included among them. As used herein, a situation of use is internal information of the electronic device 1 or external information. Internal information may be, in the case where the electronic device 1 is used for the car navigation system 6, the remaining amount of gasoline in the automobile, temperature in the automobile, wear of the tires, or the like. It may also be settings or the like of the car navigation system 6 by the user, e.g., “expressways first” or “local roads first”. In the case where the electronic device 1 is used for a smartphone, it may be the remaining amount of the battery, received intensity of radiowaves, the orientation and tilt of the smartphone, the remaining capacity of the memory or HDD, or the like. In the case where the electronic device 1 is used for a camera, it may be lens information, e.g., the angle of view or F number.

External information may be, in the case where the electronic device 1 is used for the car navigation system 6, lanes during travel, traffic congestion, road gradient, information concerning traffic regulations, road width, or the like. In the case where the electronic device 1 is used for a portable navigation system, it may be information concerning the presence or absence of a stairway or steps, an escalator, or the like. In the case where the electronic device 1 is used for a camera, it may be information such as the subject position.

The above situations of use are described as examples, and are not limitations.

The touch pad 10 is disposed in a place where it can be touched by a user, and is composed of a material having a certain level of rigidity, e.g., resin, glass, metal, or a composite material thereof.

As the method of detecting a touch on the touch pad 10, known methods may be used, e.g., pressure-sensing, capacitance, optical, or surface acoustic wave. The touch pad 10 detects a touch made on the touch pad 10 by the user with a means of manipulation such as a finger or a touch pen, and detects the coordinates of a point of contact, i.e., a touched position on the touch pad 10. Moreover, the touch pad 10 is capable of simultaneously detecting a plurality of points of contact.

The touch pad 10 is fixed to the vehicle body 5 via the spacer 4. The spacer 4 is composed of a material having certain levels of mechanical strength and elasticity, e.g., resin, metal, rubber, gel, or a composite material thereof, thus having a rigidity for supporting the touch pad 10.

As the method of fixing the touch pad 10 and vehicle body 5 and the spacer 4, fastening with screws, adhesive bonding with an adhesive, attachment via a double-coated adhesive tape, or other methods that provide a certain level of mechanical strength may be used. Alternatively, the spacer 4 and touch pad 10 and the vehicle body 5 may be formed integrally.

Note that the electronic device 1 may not be disposed between the driver's seat and the passenger seat. The touch pad 10 may be placed on the dashboard, on an input screen of the car navigation system 6, or on the steering wheel.

<Construction of Piezoelectric Element 210>

Next, with reference to FIG. 2A and FIG. 2B, an exemplary construction of the piezoelectric element 210 will be described. FIG. 2A shows the appearance of the piezoelectric element 210. The piezoelectric element 210 includes a piezoelectric member 212, a first terminal P, a second terminal N, a reference electrode 216, and a third terminal G. As shown in FIG. 2A, the piezoelectric member 210 having e.g. a rectangular solid shape includes a mounting face 212b, a principal face 212a, a side face 212c, a side face 212d, a side face 212e, and a side face 212f. The mounting face 212b and the principal face 212a constitute a pair of parallel faces of the rectangular solid. The reference electrode 216 is provided so as to cover the entire mounting face 212b. For external connection, the first terminal P, the second terminal N, and the third terminal G are provided on at least one face among the principal face 212a, the mounting face 212b, the side face 212c, the side face 212d, the side face 212e, and the side face 212f.

In this example, the first terminal P is provided upon the principal face 212a and the side face 212c; the second terminal N is provided upon the principal face 212a and the side face 212d; and the third terminal G is provided upon the principal face 212a and the side face 212c. The third terminal G is electrically connected to the reference electrode 216. The third terminal G is placed between the first terminal P and the second terminal N. This is because the inter-terminal potential difference between the third terminal G and the first terminal P or second terminal N is smaller than the potential difference between the first terminal P and the second terminal N, which makes it more advantageous in terms of electrical clearance to place the third terminal G between the first terminal P and the second terminal N.

The third terminal G, the first terminal P, and the second terminal N are formed at an end of the principal face 212a of the piezoelectric member. This is in order not to hinder vibration of the piezoelectric element 210 when a wire, flexible cable, or the like is connected to the piezoelectric element 210, because vibration of the piezoelectric element 210 is greater in the central portion than at the ends.

FIG. 2B is a cross-sectional view along the longitudinal direction of the piezoelectric element 210 shown in FIG. 2A. As shown in FIG. 2B, the piezoelectric element 210 is adhesively bonded, with an adhesive material 250 such as an epoxy-type adhesive, a UV-curable resin, or a double-coated adhesive tape, so that the mounting face 212b opposes a rear face 10a of the touch pad 10.

In the case where connection lines and the like are present on the rear face 10a of the touch pad 10, such that electrical conduction may possibly occur between the reference electrode 216 of the piezoelectric element 210 and the touch pad 10, an insulative adhesive material 250 is to be used.

In order to efficiently transmit the vibration of the piezoelectric element 210 to the touch pad 10, the adhesive material 250 generally has a high rigidity. However, excessive rigidity would likely cause strain under high temperature or low temperature, due to a difference in coefficient of thermal expansion between the piezoelectric element 210 and the touch pad 10. For this reason, the adhesive member 250 has a smaller rigidity than those of the piezoelectric element 210 and the touch pad 10.

As shown in FIG. 2B, the piezoelectric element 210 further includes a plurality of first internal electrodes 214a and a plurality of second internal electrodes 214b alternately placed in the interior of the piezoelectric member 212 at predetermined interspaces. The plurality of first internal electrodes 214a are electrically connected to the first terminal P via a first external electrode 215a. Similarly, the plurality of second internal electrodes 214b are electrically connected to the second terminal N via a second external electrode 215b. The piezoelectric member 212 contains a piezoelectric material such as lead titanate, lead zirconate titanate, or lithium niobate.

The portions of the piezoelectric member 212 interposed between the first internal electrodes 214a and the second internal electrodes 214b are polarized. The polarization direction alternates, as indicated by arrows in FIG. 2B. The other portions of the piezoelectric member 212 are not polarized. In particular, it is desirable that the portions interposed between any first internal electrode 214a or second internal electrode 214b of the piezoelectric member and the reference electrode 216 are not polarized. This is in order to prevent unwanted vibration.

The first external electrode 215a and the second external electrode 215b are made of a metal such as silver, palladium, copper, or nickel, or a composite containing such metals, by method such as printing, sputtering, welding, or metallikon. Due to their formation methods, the first external electrode 215a and the second external electrode 215b may partly be formed on the mounting face 212b. An insulator layer 251 may in advance be formed on the piezoelectric element 210 to prevent any first external electrode 215a and second external electrode 215b formed on the mounting face 212b from having contact with the touch pad 10. The insulator layer 251 can be composed of a resin such as epoxy resin or acrylic resin, or an electrically insulative material such as glass, ceramic, or piezoelectric materials.

The piezoelectric element 210 having the insulator layer 251 formed thereon is adhesively bonded to the touch pad 10 via the adhesive layer 250. In the case where the surface of the touch pad 10 is insulated and there is little influence of electromagnetic noise associated with the sensing method of the touch pad 10, etc., the insulating layer 251 may not be necessary. The first terminal P, the second terminal N, and the third terminal G of the piezoelectric element 210 are each electrically connected to the control section 220.

By applying a voltage to the piezoelectric member 212 via the first terminal P and the second terminal N, the piezoelectric element 210 will try to expand or contract in accordance with an electric field associated with the voltage. However, the piezoelectric element 210 is attached to the touch pad 10 and the touch pad does not expand or contract; therefore, the touch pad 10 flexes due to stress in the piezoelectric element 210. By applying an AC voltage to the first terminal P and the second terminal N, the touch pad 10 undergoes flexural vibration.

Generally speaking, it is necessary to apply a high voltage in order to expand or contract a piezoelectric member. However, the touch pad 10 is expected to be touched by a user with a finger of a hand or the like, so that too high a voltage cannot be applied. For this reason, the piezoelectric element 210 has a multilayer structure in which the plurality of first internal electrodes 214a and the plurality of second internal electrodes 214b are alternately placed in the interior of the piezoelectric member via the piezoelectric member, so that an electric field of a sufficient mechanical strength can be applied to the piezoelectric member even at a low voltage. This makes it possible to narrow the interspaces between electrodes, and generate a high electric field even at a low voltage. Moreover, in order to prevent electromagnetic noise from occurring on the touch pad 10 due to the driving voltage for the piezoelectric element 210, the reference electrode 216 is located between the piezoelectric element 210 and the touch pad 10. The reference electrode 216 is formed on the surface of the piezoelectric element 210 facing the touch pad 10, or on the internal electrode that is the closest to the touch pad 10.

FIG. 2B illustrates that the reference electrode 216 is formed on the surface of the piezoelectric element 210. However, the reference electrode 216 may be separate from the piezoelectric element 210, and made of e.g., a metal foil or the like. In order not to cause unwanted resonation, the thickness of the piezoelectric member may be such that a thickness to of the outermost layer of the piezoelectric member is greater than a thickness ti of any layer of the piezoelectric member that is interposed between a first internal electrode 214a and a second internal electrodes 214b.

The piezoelectric element 210 is attached on the pad 10. Furthermore, it includes the electrode 216 connected to the reference potential is provided on the face at which it is attached to the pad 10. As a result, any noise that may occur due to driving of the piezoelectric element 210 is restrained from propagating to the touch pad 10, so that the touch pad 10 is able to stably detect the user's manipulation.

The illustrated piezoelectric element 210 includes: the piezoelectric member 212 having the mounting face 212b and at least one other face; the plurality of first internal electrodes 214a and plurality of second internal electrodes 214b alternately placed in the interior of the piezoelectric member 212 at predetermined interspaces; the first terminal P electrically connected to the plurality of first internal electrodes 214a and provided on at least one other face; the second terminal N electrically connected to the plurality of second internal electrodes 214b and provided on at least one other face; the reference electrode 216 provided on the mounting face 212b of the piezoelectric member 212; and the third terminal G electrically connected to the reference electrode 216 and provided on at least another face. The reference electrode 216 and the first internal electrode 214a or second internal electrode 214b that is the closest to the reference electrode 216 are not polarized. Alternatively, polarization may be adopted only between the first internal electrode 214a and second internal electrode 214b which are not the reference electrode 216. Note that the first terminal P, the second terminal N, and the third terminal G may be located toward an end from the substantially center of the principal face 212a.

[1-2. Operation]

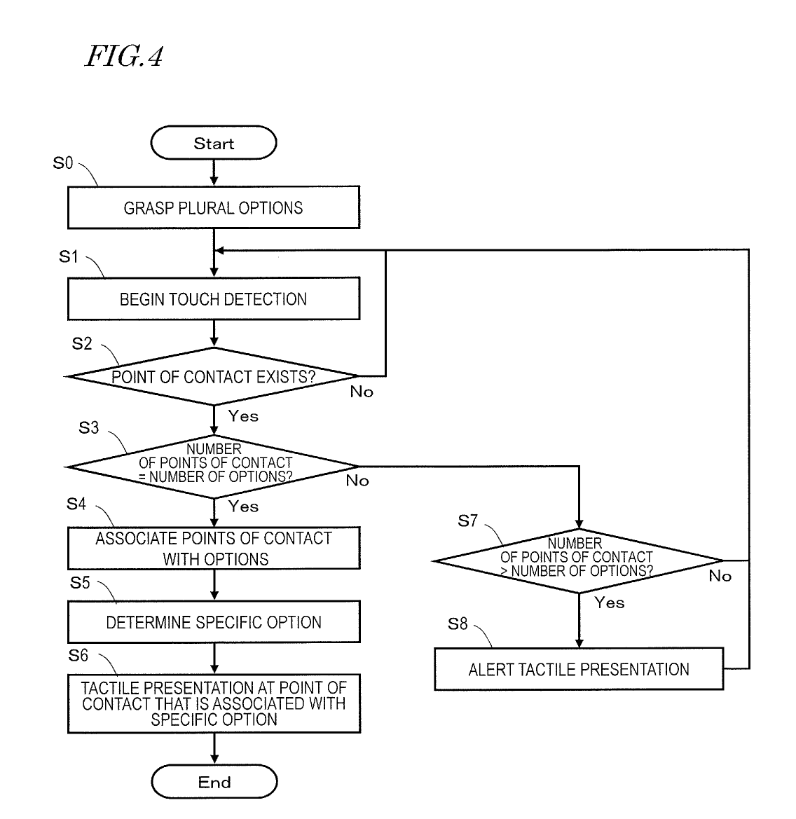

Next, with reference to FIG. 3A to FIG. 5C, an example operation of the electronic device 1 will be described. Among a plurality of touched positions on the touch pad 10, the electronic device 1 presents a tactile sensation at a touched position which is associated with a specific option, this tactile sensation being distinct from that for any other touched position.

FIG. 3A shows a road situation during travel of an automobile 50 having the electronic device 1. The direction of travel of the automobile 50 is defined as the Y direction; the direction which is orthogonal to the direction of travel of the automobile 50 and yet is horizontal is defined as the Xdirection; and the vertical direction with respect to the road is defined as the Z direction.

The automobile 50 is traveling along a road 7 which has three lanes per direction. The left lane is a left-turn lane 7a; the middle lane is a go-straight lane 7b; and the right lane is a right-turn lane 7c. The automobile 50 is now traveling in the go-straight lane 7b. In this example, the specific option sought by the person who is driving the automobile 50, i.e., the user, is one of the lanes in FIG. 3A.

FIG. 3B shows an example method of presenting information to the user via tactile sensation. The X-Y directions on the touch pad 10 correspond to the X-Y directions of the automobile 50 as shown in FIG. 3A. When the user touches the touch pad 10 with three fingers, the touch pad 10 detects the X coordinate of the point of contact of each finger, and the control section 220 maps the coordinates of the point of contact of a finger K to the left-turn lane 7a, the coordinates of the point of contact of a finger L to the go-straight lane 7b, and the coordinates of the point of contact of a finger M to the right-turn lane 7c.

Based on a destination which is designated by the user, the congestion information for the road, and so on, the car navigation system 6 determines a lane to recommend to the user. If the recommended lane is the right-turn lane 7c, as shown in FIG. 3B, a tactile sensation is presented only at the touched position of the finger M, which is associated with the right-turn lane 7c. Since a tactile sensation is presented only to the finger M, the user knows that it is recommended to go in the right-turn lane 7c.

In the present embodiment, distinct tactile sensations are presented to a plurality of fingers touching the touch pad 10. Known techniques can be employed to vibrate only specific positions of the touch pad 10. For example, it can be attained by placing a plurality of piezoelectric elements 210 on the rear face of the touch pad 10, and changing the driving method for the plurality of piezoelectric elements 210 depending on the point of contact. Alternatively, the user may wear means of tactile presentation on each finger, and distinct tactile sensations may be given to the finger that is associated with a specific option among the plurality of fingers touching the touch pad 10 and to the other fingers.

Note that the method of presenting distinct tactile sensations to the plurality of fingers is not limited to the above methods.

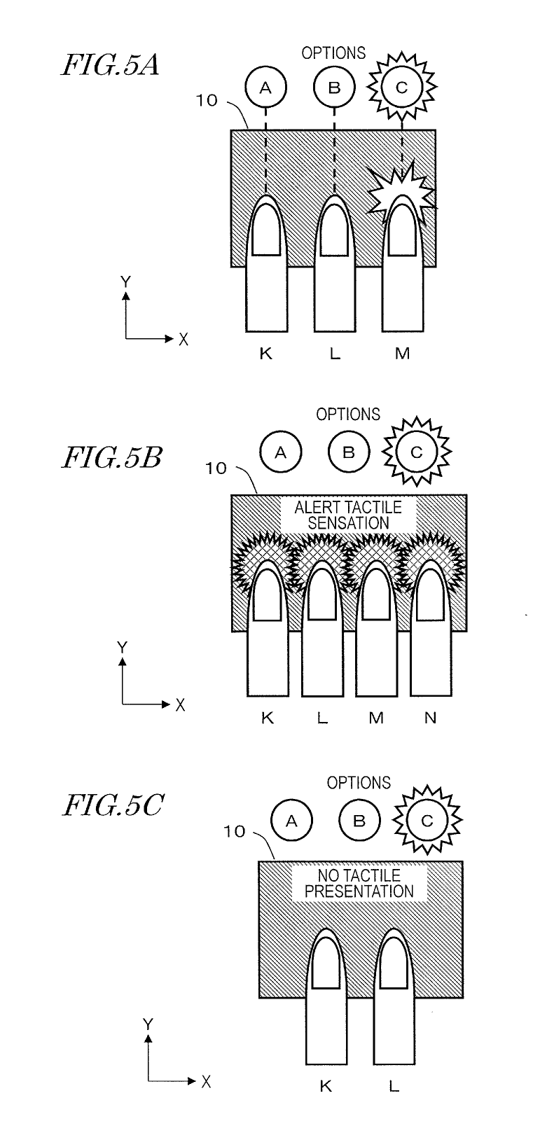

With reference to FIG. 4 to FIG. 5C, the operation of the electronic device 1 of the present embodiment will be further described.

FIG. 4 is a flowchart for describing the operation of the electronic device 1. First, depending on the situation of use of the electronic device 1, the control section 220 determines plural options among which a specific option is included (step S0). In the example shown in FIG. 3A and FIG. 3B, the plural options are the lanes 7a, 7b, and 7c, and the specific option is the right-turn lane 7c. Next, the control section 220 begins detection of a touch on the touch pad 10 by the user (step S1). The control section 220 regularly confirms whether the user has a made a touch on the touch pad (step S2). If a touch has been made, the control section 220 determines whether the number of points of contact is equal to the number of options (step S3).

If the number of points of contact and the number of options are equal, the control section 220 maps the respective options to the fingers touching the touch pad 10 in one-to-one correspondence, as shown in FIG. 5A (step S4). In the example of FIG. 5A, the number of options is three, and the number of fingers is three. In FIG. 5A, option A is mapped to the finger K, option B to the finger L, and option C to the finger M. Mapping is done based on the X coordinate of the point of contact of each finger, for example.

Next, if the number of points of contact and the number of options are equal (Yes from step S3), the control section 220 maps the points of contact to the options in one-to-one correspondence (step S4), and determines a specific option (step S5). In FIG. 5A, the specific option is option C.

The options may be the lanes of a road, for example. The specific option may be a recommended lane that is determined based on information concerning the situation of use for the electronic device 1, e.g., traffic congestion on the road, or navigation information until a destination which is designated by the user, for example.

Next, a tactile sensation is presented only at the point of contact that is mapped to the specific option (step S6). In FIG. 5A, a tactile sensation is presented only at the point of contact of the finger M, which is mapped to the specific option, i.e., option C. As a result, the user knows that option C is being recommended.

If the number of points of contact and the number of options are not equal (No from step S3), the control section 220 determines whether or not the number of points of contact is greater than the number of options (step S7). If the number of points of contact is greater than the number of options (Yes from S7), as in FIG. 5B (three options; four fingers touching the touch pad 10), an alert tactile sensation is presented to all fingers (step S8). The alert tactile sensation is distinct from the tactile sensation that is given to the finger which is associated with the specific option in FIG. 5A. For example, the alert tactile sensation is stronger than the tactile sensation that is given to the finger which is associated with the specific option in FIG. 5A. Note that the method of presenting the alert tactile sensation is not limited to these.

As a result, the user knows that the number of fingers touching the touch pad 10 is greater than the number of options. After the alert tactile sensation is presented, detection of a point of contact is continued (back to step S2).

By varying the vibration of the touch pad 10 based on the driving method of the piezoelectric element 210, the intensity of tactile sensation can be varied. For example, the tactile sensation will become more intense if the vibration amplitude of the touch pad 10 is increased. Moreover, the tactile sensation will become more intense if the touch pad 10 is vibrated for a longer time. When the frequency of vibration of the touch pad 10 is 200 to 300 Hz, a more intense tactile sensation can be presented than when the frequency of vibration of the touch pad 10 is less than 200 Hz or higher than 300 Hz.

If the number of points of contact is smaller than the number of options (No from step S7), as shown in FIG. 5C (the number of options is three; the number of fingers touching the touch pad 10 is two), no tactile sensation is presented, and detection of a point of contact is continued (back to step S1). As a result, the user knows that the number of fingers touching the touch pad 10 is smaller than the number of options.

Thus, the electronic device 1 of the present embodiment notifies a specific option from among plural options to the user. The electronic device 1 includes the touch pad 10, the control section 220, and the piezoelectric element 210.

The touch pads 10 detects points of contact at which the user has made a touch. The piezoelectric element 210 presents vibration at at least some the points of contact. In accordance with the situation of use for the electronic device 1 (setting of the car navigation system 6 by the user, e.g., “expressways first” or “local roads first”), the control section 220 determines plural options, among which a specific option is included. Moreover, the control section 220 maps options to the points of contact. Then, when the touch pad 10 detects the points of contact, the piezoelectric element 210 presents different tactile sensations at a point of contact that is mapped to the specific option (recommended lane) (i.e., a finger touching the touch pad which is mapped to the specific option) and at any other point of contact.

With such construction, a specific option among plural options can be notified via tactile sensation.

### Embodiment 2

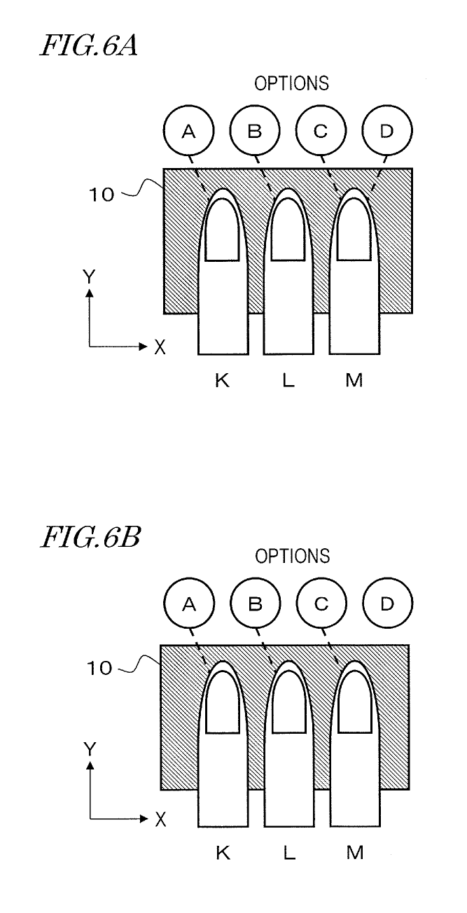

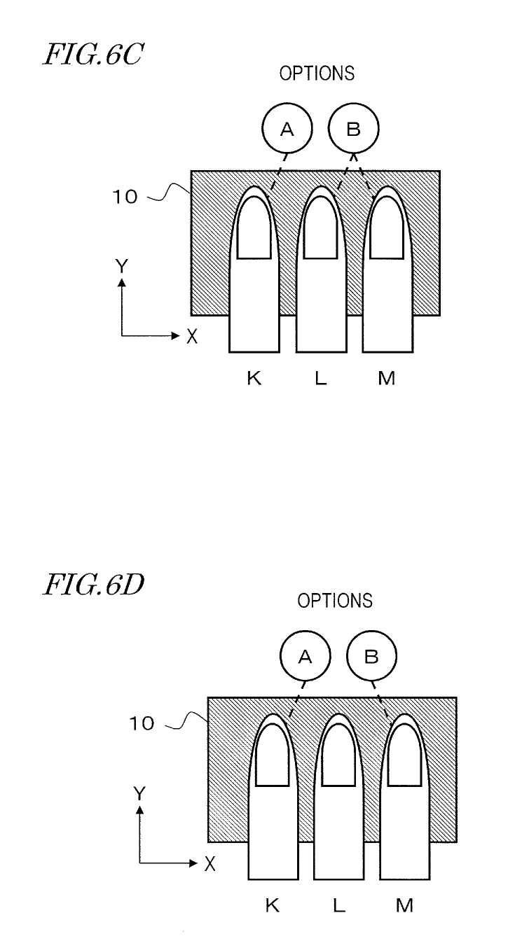

Next, with reference to FIG. 6A to FIG. 6D, an operation of an electronic device 1 according to Embodiment 2 will be described. Those component elements which have identical counterparts in Embodiment 1 will be denoted by the same reference numerals, and may not be described again. In Embodiment 1 above, options and fingers are associated in one-to-one correspondence only when the number of options is equal to the number of fingers touching the touch pad 10. In the present embodiment, options and fingers are associated even when the number of options is not equal to the number of fingers touching the touch pad 10. Hereinafter, this will be described with reference to the drawings.

In FIG. 6A and FIG. 6B, there are four options and three fingers. That is, the number of options is greater than the number of points of contact.

In such a case, for example, two or more of the plural options are mapped to at least one predetermined point of contact among the plurality of points of contact. For example, as shown in FIG. 6A, plural options may be mapped to one finger. For example, option C and option D may be mapped to the finger M. In such a case, a tactile sensation is presented to the finger M whether the recommended specific option is option C or option D. As a result, the user knows that the specific option is at least option C or option D. Moreover, in this case, the tactile sensation to be given to the finger M may be changed depending on whether the specific option is option C or option D. For example, the touch pad 10 may be vibrated once if the specific option is option C, and the touch pad 10 may be vibrated twice if the specific option is option D. This allows the user to recognize whether the specific option is option C or option D.

Moreover, for example, at least one option among the plural options may not be mapped to any of the plurality of points of contact. For example, as shown in FIG. 6B, option D may not be mapped to any finger. In this case, no tactile sensation is presented when the specific option is option D. This allows the user to recognize that the specific option is option D if no tactile sensation is presented.

In FIG. 6C and FIG. 6D, there are two options and three fingers. That is, the number of options is smaller than the number of points of contact.

In such a case, for example, at least one predetermined option among the plural options is mapped to two or more of the plurality of points of contact. For example, as shown in FIG. 6C, one option may be mapped to plural fingers. For example, option B may be mapped to the finger L and the finger M. In such a case, if the recommended specific option is option B, a tactile sensation is presented to the finger L and the finger M. This allows the user to know that the recommended specific option is option B.

Moreover, none of the plural options may be mapped to at least one of the plurality of points of contact. For example, as shown in FIG. 6D, no option may be mapped to the finger L. In such a case, a tactile sensation is presented to the finger K if the recommended specific option is option A, and a tactile sensation is presented to the finger M if the specific option is option B. This allows the user to know the recommended specific option.

In the present embodiment, mapping is performed even when the number of options is not equal to the number of fingers touching the touch pad 10, and a tactile sensation is presented to the finger(s) mapped to the specific option. This allows the user to know the recommended specific option even when the number of options is not equal to the number of fingers touching the touch pad 10.

### Embodiment 3

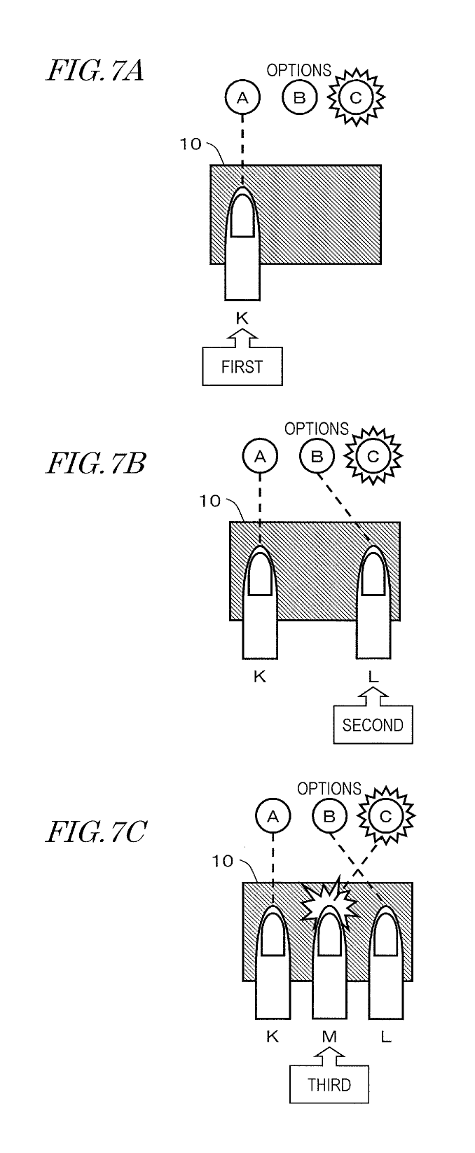

Next, with reference to FIG. 7A to FIG. 7C, an operation of an electronic device 1 according to Embodiment 3 will be described. Those component elements which have identical counterparts in Embodiment 1 will be denoted by the same reference numerals, and may not be described again. In Embodiment 1, options and fingers are associated based on relative positioning between the coordinates of points of contact of the fingers touching the touch pad 10. In the present embodiment, options and fingers are associated based on the order in which the respective fingers have touched the touch pad 10. Hereinafter, this will be described with reference to the drawings.

In the present embodiment, plural options are associated with a plurality of fingers based on the order in which the fingers have touched the touch pad 10. For example, as shown in FIG. 7A, the finger that was the first to touch is designated a finger K; as shown in FIG. 7B, the finger that was the second to touch is designated a finger L; as shown in FIG. 7C, the finger that was the third to touch is designated a finger M. In this case, the control section 220 maps option A to the finger K, option B to the finger L, and option C to the finger M, irrespective of the relative positioning between the coordinates of points of contact of the respective fingers touching the touch pad 10. If the specific option is option C, a tactile sensation is presented only at the point of contact of the finger M. This allows the user to know that the specific option is option C.

In the present embodiment, options and fingers are associated based on the order in which fingers have touched the touch pad 10. Therefore, even if the user does not know the number of options, the specific option will be mapped to a finger touching the touch pad 10 as the number of fingers touching the touch pad 10 is consecutively increased, whereby a tactile sensation will be presented. This allows the user to know the specific option without knowing the number of options.

### Embodiment 4

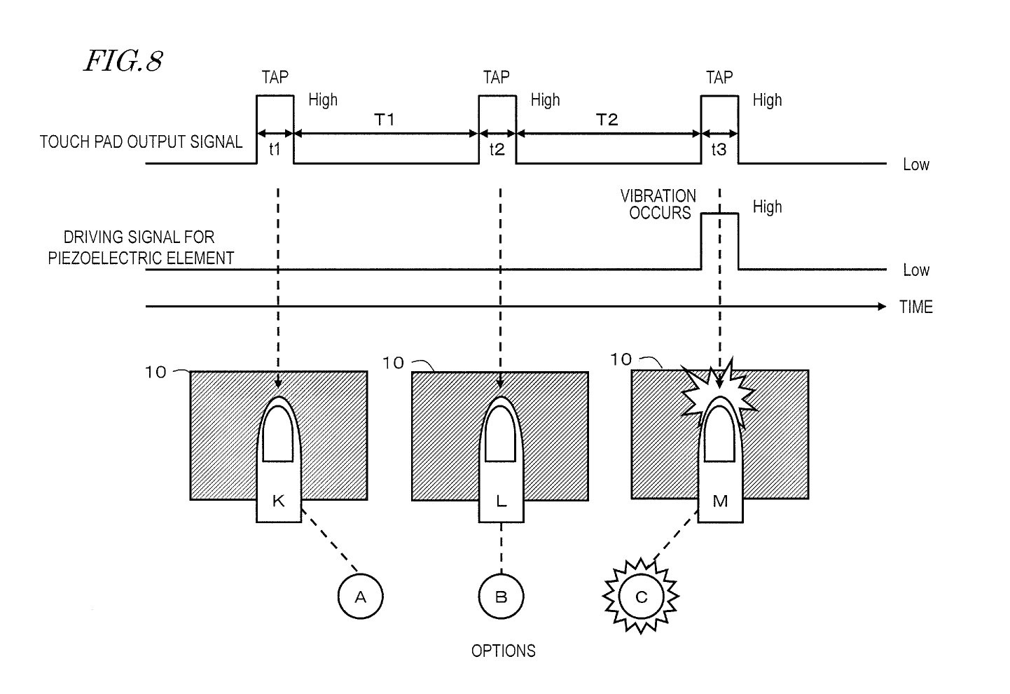

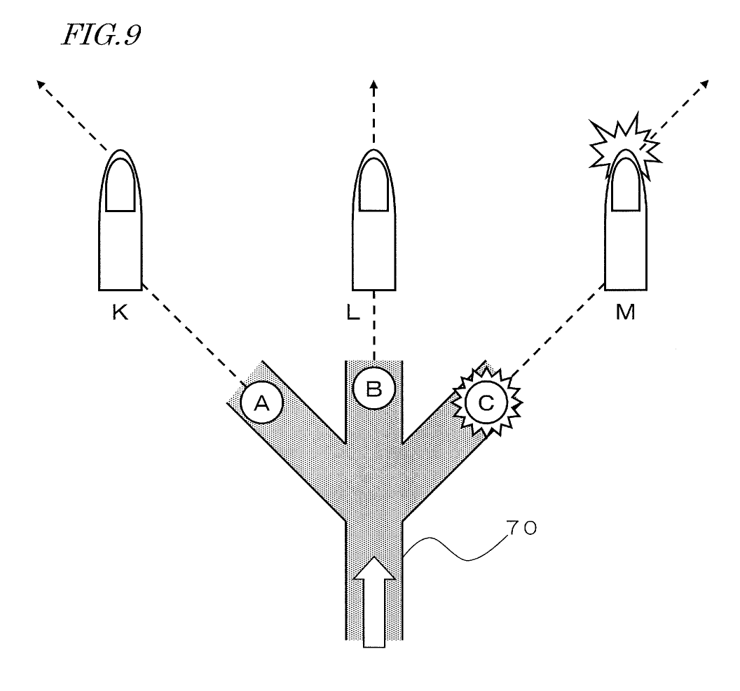

Next, with reference to FIG. 8, an operation of an electronic device 1 according to Embodiment 4 will be described. Those component elements which have identical counterparts in Embodiment 1 will be denoted by the same reference numerals, and may not be described again.

In Embodiments 1 to 3, options are mapped to a plurality of fingers simultaneously touching the touch pad 10. In the present embodiment, a tactile sensation which is distinct from that for any other touch is presented for a touch which is associated with a specific option. For example, when the user has tapped on the touch pad 10 a plurality of times in succession, options and fingers are associated based on the number of taps having been made. As used herein, a tap refers to an action of touching a finger on the touch pad 10 and lifting the finger off the touch pad 10 within a certain length of time. For example, t1, t2, and t3, which are lengths of time during which a finger keeps touching the touch pad 10, are within 1 second. The tap operations may be made on the same position or at different positions on the touch pad 10.

FIG. 8 shows an output signal from the touch pad 10 and a driving signal for the piezoelectric element 210. The horizontal axis represents time. The output signal from the touch pad 10 being High means that at least one finger is touching the touch pad 10. The output signal from the touch pad 10 being Low means that no finger is touching the touch pad 10. The driving signal for the piezoelectric element 210 being High means that power is supplied to the piezoelectric element 210 so that the piezoelectric element 210 is vibrating the touch pad 10. The driving signal for the piezoelectric element 210 being Low means that the touch pad 10 is not vibrating.

In FIG. 8, three successive tap actions are performed. The finger which made the first tap is designated a finger K; the finger which made the second tap is designated a finger L; and the finger which made the third tap is designated a finger M. In FIG. 8, the fingers K, L, and M may be the same finger or different fingers, so long as they make taps at different points in time.

As shown in FIG. 8, option A is mapped to the finger K; option B to the finger L; and option C to the finger M. If the specific option is option C, a tactile sensation is presented to the finger M which made the third tap. In other words, the driving signal for the piezoelectric element 210 goes High only while the finger M, which made the third tap, is touching the touch pad 10 to vibrate the touch pad 10. This allows the user to know that the specific option is option C.

Moreover, if the amount of time between one tap and another exceeds a certain length of time, they may not be regarded as successive tap actions. For example, if the time T1 or T2 between taps exceeds 5 seconds, the tap actions may not be regarded as successive. This prevents successive tap actions from being established against the intention of the user.

In the present embodiment, the user is able to know the specific option without simultaneously touching the touch pad 10 with a plurality of fingers. Therefore, the user is able to know the specific option even when the touch pad 10 cannot detect touches of a plurality of fingers, or when there is only one means of manipulation being available for use, e.g., a touch pen.

### Embodiment 5

Next, an operation of an electronic device 1 according to Embodiment 5 will be described with reference to FIG. 9. Those component elements which have identical counterparts in Embodiment 1 will be denoted by the same reference numerals, and may not be described again. In the present embodiment, when the user has made a sliding action on the touch pad 10, plural options are associated with a plurality of directions of slide. As used herein, a sliding action means an action of a finger which is moved by a certain amount or more on the touch pad 10 while the finger remains in touch with the touch pad 10.

In the present embodiment, when the user makes a sliding action on the touch pad 10, plural options are associated with a plurality of directions of slide on the touch pad 10. For example, in a four-way intersection 70 as shown in FIG. 9, the available options may be roads A to C. If the user makes a sliding action on the touch pad 10 in substantially the same direction as road A, as with a finger K, then the finger K is mapped to road A. Similarly, if the user makes a sliding action in substantially the same direction as road B, e.g., a finger L, then the finger L is mapped to road B. If the user makes a sliding action in substantially the same direction as road C, e.g., a finger M, then finger M is mapped to road C. If the recommended road is road C, a tactile sensation is presented only at the touched position of the finger M. This allows the user to know that road C is the recommended road. Note that, when the face of the touch pad 10 is horizontal to a road, substantially the same direction means a direction corresponding to the road, for example. When the touch pad 10 includes a display panel, for example, it may be the direction of the road displayed on the screen. When the touch pad 10 is tilted, for example, it may be a projected direction of the direction of slide onto the road. Note that the fingers K, L, and M may be different fingers or the same finger of the user.

In the present embodiment, the user is able to know the specific option without simultaneously touching the touch pad 10 with a plurality of fingers. Therefore, the user is able to know the specific option even when the touch pad 10 cannot detect touches of a plurality of fingers, or when there is only one means of manipulation being available for use, e.g., a touch pen. Furthermore, since directions of slides match directions of roads, the user can intuitively grasp the recommended road even in the case of complicated roads.

### Embodiment 6

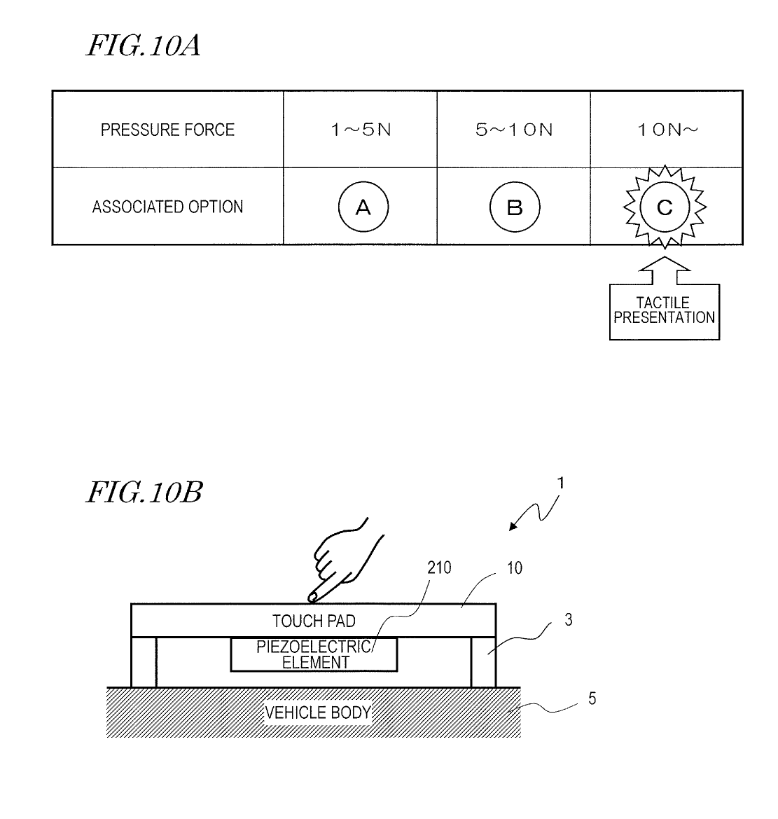

Next, with reference to FIG. 10A and FIG. 10B, an operation of an electronic device 1 according to Embodiment 6 will be described. Those component elements which have identical counterparts in Embodiment 1 will be denoted by the same reference numerals, and may not be described again. In the present embodiment, the magnitude of the pressure force of a touch by the user on the touch pad 10 is associated with plural options.

FIG. 10A is a table showing pressure forces and associated options according to the present embodiment. Any pressure force which is 1 N or greater but less than 5 N is mapped to option A; any pressure force which is 5 N or greater but less than 10 N is mapped to option B; and any pressure force which is 10 N or greater is mapped to option C. If the specific option is option C, a tactile sensation is presented only when a press with a force of 10 N or more is made. This allows the user to know that the specific option is option C.

The user's pressure force on the touch pad 10 can be measured by placing a load cell 3 between the touch pad 10 and the vehicle body 5 as shown in FIG. 10B, for example. Alternatively, the piezoelectric element 210 for vibrating the touch pad 10 may measure a flexural amount of the touch pad 10. Alternatively, a strain gauge (not shown) for measuring the flexural amount of the touch pad 10 may be further included. Moreover, a pressure force may be estimated from the area of contact of the user's finger on the touch pad 10. In other words, any other method may be made that is able to measure a pressure force of the user on the touch pad 10.

In the present embodiment, the user is able to know the specific option without simultaneously touching the touch pad 10 with a plurality of fingers. Therefore, the user is able to know the specific option even when the touch pad 10 cannot detect touches of a plurality of fingers, or when there is only one means of manipulation being available for use, e.g., a touch pen.

In the case where the options are analog values, their values can be intuitively grasped. For example, if the options are distances to a destination, such that option A means less than 50 km, option B means 50 km or greater but less than 100 km, and option C 100 km or greater, then the distance to the destination can be intuitively grasped because there is correlation between the magnitude of a pressure force and the distance to the destination.

### Other Embodiments

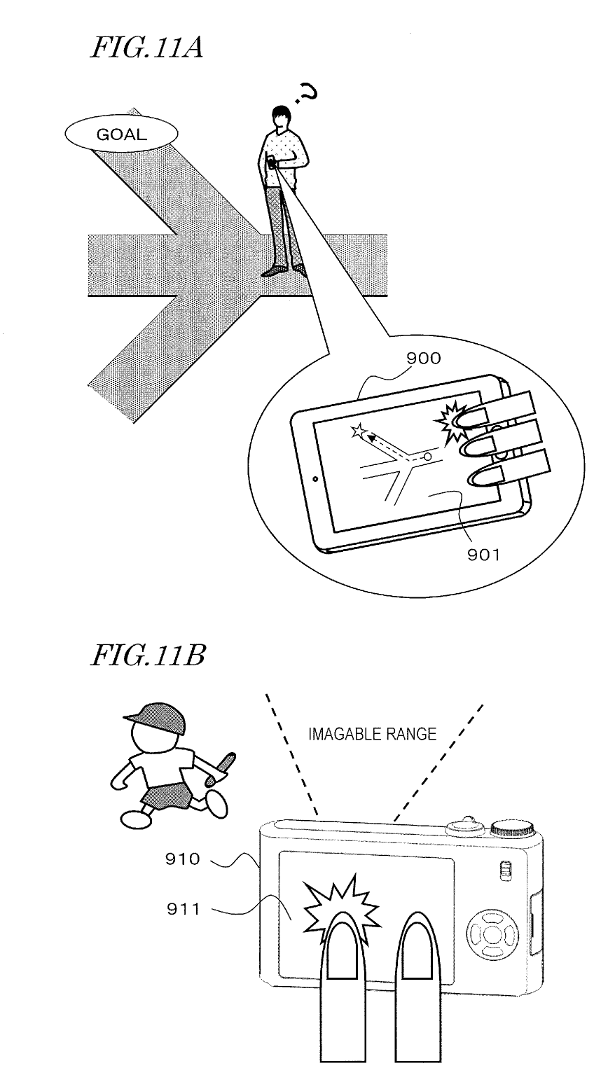

Although Embodiments 1 to 6 above illustrate that the electronic device 1 is mounted on an automobile, this is not a limitation. For example, as shown in FIG. 11A, the electronic device 1 may be a smartphone 900. For example, if a touch pad 901 is touched with a plurality of fingers while a walking navigation assistance function is used, a tactile sensation may be presented to a finger that is associated with the recommended road, thereby notifying the recommended road to the user. Even in the case where the user is simultaneously using another function in addition to the walking navigation assistance function, such that the user does not want the walking navigation assistance function to display a map on the screen, the recommended road can be grasped by touching the touch pad with a plurality of fingers. Even when the smartphone 900 is in a pocket or a bag, never to be taken out, the recommended road can be grasped by touching the touch pad with a plurality of fingers. Moreover, less battery power is consumed because the recommended road can be grasped without displaying a smartphone screen.

Moreover, the electronic device 1 may be a digital camera 910 as shown in FIG. 11B. For example, when a touch pad 911 of the digital camera 910 is touched with a plurality of fingers, a tactile sensation may be presented to a finger in the direction in which a subject to be photographed exists, whereby the direction in which the subject to be photographed exists.

Note that it may be a finger that touches. A touch pen will suffice. Moreover, the touch pad 10 may be transparent, and a display may be placed on the rear face of the touch pad 10. In this case, the touch pad 10 is a transparent touch panel which allows the user to see a displayed image on the display. Moreover, the touch pad 10 does not need to have a planar shape, but may have a curved-surface shape or a spherical shape, with no limitation to the shape. There may a plurality of touch pads 10, instead of one. A plurality of points of contact may exist on separate touch pads 10.

Although the embodiments are described by taking automobiles, smartphones, cameras as examples, these are not limitations. Any electronic device having a touch input interface is applicable.

The tactile presentation does not need to be vibration. Electrostatic suction may be applied to fingers, or electrical shocks may be applied. The vibration means does not need to be a piezoelectric element, but may be an eccentric motor, a voice coil motor, an artificial muscle, or the like.

Moreover, the piezoelectric element 210, as the tactile presentation section, does not need to be provided in the electronic device 1. For example, it may be provided in a means of manipulation such as a touch pen or a glove.

Moreover, the control operation OF the electronic device 1 described above may be implemented in hardware or software. A computer program for executing such control operations may be stored in an internal memory of a microcomputer or in a storage medium which is separately provided in addition to a microcomputer, for example. Alternatively, the control section 220 may store such a computer program. Moreover, such a computer program may be installed to the electronic device 1 from a storage medium (an optical disk, a semiconductor memory, etc.) in which it is stored, or downloaded via telecommunication lines such as the Internet.

### SUMMARY

As described above, a method according to an embodiment of the present disclosure is a method of notifying a specific option among plural options to a user by using an electronic device 1, the method including a step of detecting plural touches made by a user on the touch pad 10, wherein, the plural options including the specific option are determined according to a situation of use of the electronic device 1, and a plurality of touched positions on the touch pad 10 are associated with the plural options, the method further including a step of a presenting a tactile sensation at a touched position among the plurality of touched positions that is associated with the specific option, the tactile sensation being distinct from that for any other touched position.

For example, the step of detecting plural touches on the touch pad 10 may include a step of detecting coordinates of a plurality of touched positions on the touch pad 10.

For example, a step of associating the coordinates of the plurality of touched positions with the plural options may be further included.

For example, a step of presenting different tactile sensations depending on whether the number of plural touches on the touch pad 10 and the number of plural options are equal or not may be included.

For example, a step of, when the number of plural touches on the touch pad 10 and the number of plural options are equal, associating the plurality of touched positions with the plural options in one-to-one correspondence may be further included.

For example, a step of, when the number of plural options is greater than the number of plural touches on the touch pad 10, mapping two or more of the plural options to at least one predetermined touched position among the plurality of touched positions may be further included.

For example, a step of, when the number of plural options is greater than the number of plural touches on the touch pad 10, not mapping at least one option among the plural options to any of the plurality of touched positions may be further included.

For example, a step of, when the number of plural options is smaller than the number of plural touches on the touch pad 10, mapping at least one predetermined option among the plural options to two or more of the plurality of touched positions may be further included.

For example, a step of, when the number of plural options is smaller than the number of plural touches on the touch pad 10, mapping none of the plural options to at least one touched position among the plurality of touched positions may be further included.

For example, a step of associating the plurality of touched positions with the plural options based on an order of the plural touches may be further included.

A method according to an embodiment of the present disclosure is a method of notifying a specific option among plural options to a user by using an electronic device 1, the method including a step detecting a touch made by the user on the touch pad 10, wherein, the plural options including the specific option are determined according to a situation of use of the electronic device 1, and touches on the touch pad 10 are associated with the plural options, the method further including a step of presenting a tactile sensation in response to a touch that is associated with the specific option, the tactile sensation being distinct from that for any other touch.

For example, a step of associating numbers of touches with the plural options may be further included.

For example, a step of associating the plural options with a plurality of directions of slide on the touch pad 10 may be further included.

For example, a step of associating magnitudes of pressure force of the touch with the plural options may be further included.

An electronic device 1 according to an embodiment of the present disclosure is an electronic device 1 for notifying a specific option among plural options to a user, the electronic device 1 including: a touch pad 10 for detecting a plurality of touched positions touched by the user; and a tactile presentation section 210 for presenting a tactile sensation at at least one the plurality of touched positions, wherein, the plural options including the specific option are determined according to a situation of use of the electronic device 1; the plurality of touched positions are associated with the plural options; and the tactile presentation section 210 presents a tactile sensation at a touched position among the plurality of touched positions that is associated with the specific option, the tactile sensation being distinct from that for any other touched position.

An electronic device 1 according to an embodiment of the present disclosure is an electronic device 1 for notifying a specific option among plural options to a user, the electronic device 1 including: a touch pad 10 for detecting a touch made by the user, and a tactile presentation section 210 for presenting a tactile sensation at a touched position on the touch pad 10, wherein, the plural options including the specific option are determined according to a situation of use of the electronic device 1; touches on the touch pad 10 are associated with the plural options; and the tactile presentation section 210 presents a tactile sensation to a touch that is associated with the specific option, the tactile sensation being distinct from that for any other touch.

A computer program according to an embodiment of the present disclosure is a computer program for causing an electronic device 1 to execute a process of notifying a specific option among plural options to a user, the computer program causing a computer in the electronic device 1 to execute a process of detecting plural touches made by the user on a touch pad 10, wherein, the plural options including the specific option are determined according to a situation of use of the electronic device 1, and a plurality of touched positions on the touch pad 10 are associated with the plural options, the computer program causing the computer in the electronic device 1 to execute a process of presenting a tactile sensation at a touched position among the plurality of touched positions that is associated with the specific option, the tactile sensation being distinct from that for any other touched position.

A computer program according to an embodiment of the present disclosure is a computer program for causing an electronic device 1 to execute a process of notifying a specific option among plural options to a user, the computer program causing a computer in the electronic device 1 to execute a process of detecting a touch made by the user on a touch pad 10, wherein, the plural options including the specific option are determined according to a situation of use of the electronic device 1, and touches on the touch pad are associated with the plural options, the computer program causing the computer in the electronic device 1 to execute a process of presenting a tactile sensation in response to a touch that is associated with the specific option, the tactile sensation being distinct from that for any other touch.

Embodiments have been described above as an illustration of the technique of the present disclosure. The accompanying drawings and the detailed description are provided for this purpose. Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, substitutions, additions, omissions, etc., can be made without departing from the scope defined by the claims and the equivalents thereof.

The technique of the present disclosure is applicable to technological fields where information is presented via tactile sensation. For example, the technique of the present disclosure is applicable to car navigation systems, smartphones, mobile phones, and digital still cameras.

The entire disclosure of Japanese Patent Application No. 2013-087165, which was filed with the Japan Patent Office on Apr. 18, 2013, and Japanese Patent Application No. 2014-084303, which was filed with the Japan Patent Office on Apr. 16, 2014, is incorporated herein by reference.

What is claimed is:

1. A method of notifying a specific option among plural options to a user by using an electronic device, comprising
a step of detecting plural touches made by the user on a touch pad, wherein,
the plural options including the specific option are determined according to a situation of use of the electronic device, and
a plurality of touched positions on the touch pad are associated with the plural options, the method further comprising:
a step of presenting a tactile sensation at a touched position among the plurality of touched positions that is associated with the specific option, the tactile sensation being distinct from that for any other touched position.

2. The method of claim 1, wherein the step of detecting plural touches on the touch pad comprises a step of detecting coordinates of a plurality of touched positions on the touch pad.

3. The method of claim 2, further comprising a step of associating the coordinates of the plurality of touched positions with the plural options.

4. The method of claim 1, further comprising a step of presenting different tactile sensations depending on whether the number of plural touches on the touch pad and the number of plural options are equal or not.

5. The method of claim 1, further comprising a step of, when the number of plural touches on the touch pad and the number of plural options are equal, associating the plurality of touched positions with the plural options in one-to-one correspondence.

6. The method of claim 1, further comprising a step of, when the number of plural options is greater than the number of plural touches on the touch pad, mapping two or more of the plural options to one predetermined touched position among the plurality of touched positions.

7. The method of claim 1, further comprising a step of, when the number of plural options is greater than the number of plural touches on the touch pad, not mapping at least one option among the plural options to any of the plurality of touched positions.

8. The method of claim 1, further comprising, when the number of plural options is smaller than the number of plural touches on the touch pad, a step of mapping one predetermined option among the plural options to two or more of the plurality of touched positions.

9. The method of claim 1, further comprising a step of, when the number of plural options is smaller than the number of plural touches on the touch pad, mapping none of the plural options to at least one touched position among the plurality of touched positions.

10. The method of claim 1, further comprising a step of associating the plurality of touched positions with the plural options based on an order of the plural touches.

11. A method of notifying a specific option among plural options to a user by using an electronic device, comprising
a step of detecting a touch made by the user on a touch pad, wherein,
the plural options including the specific option are determined according to a situation of use of the electronic device, and
touches on the touch pad are associated with the plural options, the method further comprising:
a step of presenting a tactile sensation in response to a touch that is associated with the specific option, the tactile sensation being distinct from that for any other touch.

12. The method of claim 11, further comprising a step of associating numbers of touches with the plural options.

13. The method of claim 11, further comprising a step of associating the plural options with a plurality of directions of slide on the touch pad.

14. The method of claim 11, further comprising a step of associating magnitudes of pressure force of the touch with the plural options.

15. An electronic device for notifying a specific option among plural options to a user,
the electronic device comprising:
a touch pad for detecting a plurality of touched positions touched by the user; and
a tactile presentation section for presenting a tactile sensation at at least one of the plurality of touched positions, wherein,
the plural options including the specific option are determined according to a situation of use of the electronic device;
the plurality of touched positions are associated with the plural options; and
the tactile presentation section presents a tactile sensation at a touched position among the plurality of touched positions that is associated with the specific option, the tactile sensation being distinct from that for any other touched position.
